(19) United States
(12) Patent Application Publication
(10) Pub. No.: US 2021/0317047 A1
(43) Pub. Date: Oct. 14, 2021

(54) NANO/MICRO STRUCTURE IN CARBON-CARBON COMPOSITES BY TEMPLATING

(71) Applicant: The Penn State Research Foundation, University Park, PA (US)

(72) Inventors: Randall L. Vander Wal, University Park, PA (US); Madhu Singh, University Park, PA (US)

(21) Appl. No.: 17/053,385

(22) PCT Filed: May 8, 2019
(86) PCT No.: PCT/US2019/031250

§ 371 Date: Nov. 6, 2020

Related U.S. Application Data
(60) Provisional application No. 62/671,018, filed on May 14, 2018.
(60) Provisional application No. 62/670,106, filed on May 11, 2018.

(51) Int. Cl. C04B 35/83; C04B 35/634; C04B 35/64

(52) U.S. Cl. CPC C04B 35/83; C04B 35/63476; C04B 35/64; C04B 2235/656; C04B 2235/5288; C04B 2235/5292; C04B 2235/5436; C04B 2235/425

(57) ABSTRACT

A method of fabricating a carbon-carbon composite includes mixing a carbon-based matrix precursor with a carbon nanomaterial additive forming a polymeric matrix impregnated with the carbon nanomaterial additive, heating the impregnated polymeric matrix under an inert atmosphere, with temperatures ranging between 350-1100° C. for carbonization followed by graphitization at a temperature greater than 1800° C. The matrix precursor may be a graphitizing or non-graphitizing material. The additive may present basal or edge site carbon atoms or a combination of both. As a result, a carbon-carbon composite composed of the matrix and additive is formed by templating or bond formation, wherein at least 1-D nano-scale or micro-scale structural changes begins at the interface between the matrix and additive and propagates outward from the interface into the matrix, thus adjusting or altering the nano- or micro-structures in the matrix that would not naturally occur in the absence of the additive.

### REFERENCE TO RELATED APPLICATION

This application is the U.S. National Stage of PCT/US2019/031250 filed May 8, 2019, which claims priority from U.S. Provisional Patent Application Ser. No. 62/670,106, filed May 11, 2018, and U.S. Provisional Patent Application Ser. No. 62/671,018, filed May 14, 2018 the entire content of both are both incorporated herein by reference in their entirety.

### GOVERNMENT SUPPORT

This invention was made with government support under Grant No. W911NF-17-1-0513 awarded by the United States Army. The Government has certain rights in the invention.

### FIELD OF THE INVENTION

This invention relates to methods of fabricating carbon-carbon composites, specifically controlling of the nanostructure of carbon-carbon composites by templating.

### BACKGROUND OF THE INVENTION

Carbon-carbon (C—C) composites, developed about three decades ago to meet the needs of the space program, are nowadays considered high performance engineering materials with an ever-expanding range of applications. Examples include high-speed train and special automobile brakes and clutches, high thermal conductivity electronic substrates, prosthetic devices, and components for internal combustion engines. Other applications include friction components, seamless joints, lubricating products, and notably motor brushes for energy generation (e.g. wind turbines), transportation (diesel-electric) and industry (pumps).

Strength to weight ratios (stiffness) are important in aerospace and demanding mobile applications where C—C composites are five times lighter than steel and three times lighter than aluminum. Advanced military applications include engine exhaust parts for helicopters, and aircraft structures including rudders, elevators, ailerons, struts, fuselage and wing components. Vehicle parts include driveshafts, panels and brackets. Structural applications include thermal shielding panels, heat exchangers, and components for high temperature or corrosive environments. Moreover C—C composites possess excellent EM shielding effectiveness due to their high electrical conductivity.

### SUMMARY OF THE INVENTION

The present invention provides a method of fabricating a carbon-carbon composite including mixing a carbon-based matrix precursor with a carbon nanomaterial additive to form a polymeric matrix impregnated with the carbon nanomaterial additive, heating the impregnated polymeric matrix under an inert atmosphere, with temperatures ranging between 350-1100° C. for carbonization followed by graphitization at a temperature greater than 1800° C. The matrix precursor may be a graphitizing or non-graphitizing material or a continuum of graphitizing/non-graphitizing material between these nominal limits. The additive may present basal or edge site carbon atoms or a combination of both. As a result, a carbon-carbon composite composed of the matrix and additive is formed by templating or bond formation between the matrix and additive, wherein the matrix interacts physically or chemically with the carbon additive's surface, at least 1-D nano-scale or micro-scale structural changes begin at the interface between the matrix and additive during carbonization and propagate outward from the interface into the matrix with further temperature treatment and/or duration during such treatment. These expanding regions may overlap depending upon the type of carbon additive, its concentration within the matrix and process conditions. Structural refinement and/or its spatial evolution may continue under subsequent higher temperature heat treatment in following stages.

The graphitizing or non-graphitizing behavior and measurable chemical and physical characteristics of a carbon matrix precursor can be affected, altered and controlled by use of a carbon additive, thus adjusting or altering the nano- or micro-structures in the matrix that would not naturally occur in the absence of the additive. The nano- or micro-structure of the matrix is controlled by use of the additive.

The additive may be graphitic or non-graphitic or mixtures or hybrids of graphitic and non-graphitic materials or a continuum between graphitic and non-graphitic materials.

Most forms of carbon additives such as nantotubes, graphene, carbon black, carbon particles etc. may be formed, manufactured or otherwise processed to be “graphitic” or “non-graphitic”.

Alternatively, the additive may present to the matrix largely basal or edge site carbon atoms, or most commonly, some percentage of both types.

The additive may be synthetic carbon material or naturally found or produced carbon material.

In an example, the additive is pseudo-spherical particles or 1-dimensional nanotubes or graphene nano-platelets with a dimension of 1-2 μm.

The mixing of the matrix precursor with the additive is by mechanical action, solvent mediation, solvent assist, by hand, machine or other automation or instrumentation involving physical contact between the matrix precursor and additive.

The heating of the mixture is done under sub- or over-atmospheric pressure, including vacuum, using any container, vessel or other means for holding the matrix precursor mixture for exposure to convective, radiative, thermal, photonic energy sources.

Carbonization refers to any heat treatment of variable duration with temperature range nominally between 350 to over 1100° C., under sub- or over-atmospheric pressure (including vacuum), inert atmosphere using any container, vessel or other means for holding matrix plus precursor mixture for exposure to energy source (convective, radiative, thermal, photonic, etc.) by which sample temperature is elevated to the afore mentioned range for any period of time sufficient to effect a discernable elemental and/or compositional change in the sample.

Graphitization is an additional heat treatment by the same or different energy addition method to further elevate sample (matrix plus precursor) combination, to temperatures and or pressures (higher or lower) than incurred during the carbonization stage for variable periods of duration. Heating may be performed in same or different container, vessel, etc. Atmosphere may will also be inert, or may be vacuum.

Process does not exclude any number of secondary carbonization and/or subsequent heat treatment stages to higher temperatures upon or after exposure to other carbon producing precursors including hydrocarbon gases, liquids, semi-solids, thermoplastic or thermoset precursors.

Process places limit upon sample size, additive or subtractive stages as may be applied prior, between or after carbonization and subsequent heat-treatment stages.

The matrix precursor may be in the form of liquid, powder, semi-solid, liquid crystal mesophase or a material having fluidity or flexibility.

Matrices precursor may include graphitizing and non-graphitizing materials, e.g. anthracene, polymeric systems or resins, either or both synthetic or naturally occurring, petroleum or coal derived tars and pitches, other refinery products suitable for carbon matrix formation, e.g. FCC-DO, waste carbon containing materials, (e.g. plastics, tires, etc.), or carbon forms produced from such sources as recycled or re-processed material forms, a phenolic or furan based resin or polymeric systems.

Evaporative solvents are used to reduce viscosity of the matrix precursor. The carbon nanomaterial additive is added at specific weight percentage to the matrix precursor.

In an example, graphitic additives are added to non-graphitizing matrix precursors from all sources, all compositions. Graphitizing trend observed upon addition of graphene (platelets) of increasing size. Similar behaviors & trends can be observed with other graphitic additives of varied size, morphology, as perhaps nanotubes, fibers, graphitized or otherwise heat-treated carbon blacks, finely powdered graphite, coal and coal-derived graphitic materials, petroleum derived graphitic materials, waste/recycled materials reprocessed into graphitic materials, etc. All behavior and trends refer to development of a particular nano- to micro-structure originating at the matrix-additive interface and expanding outward into the matrix.

In another example, graphitic additives are added to graphitizing matrix precursors from all sources, all compositions. Non-graphitizing trend observed upon addition of graphene of decreasing size. Similar behaviors & trends may be observed with other graphitic additives of varied size, morphology, as perhaps nanotubes, fibers, graphitized or otherwise heat-treated carbon blacks, finely powdered graphite, coal and coal-derived graphitic materials, petroleum derived graphitic materials, waste/recycled materials reprocessed into graphitic materials, etc.

By using the method in accordance with an embodiment of the present invention, the carbon-carbon composite has a nanostructure selected from one of four nominal limits of structures resulting from one of four possible combinations of the matrix precursor and additive including the graphitizing matrix precursor and the graphitic additive, the graphitizing matrix precursor and the non-graphitic additive, the non-graphitizing matrix precursor and the graphitic additive, and the non-graphitizing matrix precursor and the non-graphitic additive and the continuum of graphitizing/non-graphitizing behavior between the nominal limits.

### BRIEF DESCRIPTION OF THE DRAWINGS

FIG. 1 is a schematic outline of templating upon the additive nanostructure;

FIG. 2 is a schematic outline of templating upon the additive morphology;

FIG. 3 is a schematic of the experimental approach using either a graphitizing thermoplastic or non-graphitizing thermoset as the matrix precursor plus model additives presenting either edge or basal plane (carbon atom) sites to test templating dependence upon additive nanostructure (edge or basal surface sites) and matrix precursor chemistry; and

FIGS. 4a-4d are HRTEM images of nanotubes and carbon black in non-graphitized vs. graphitized forms to test for lamellae orientation control upon matrix nanostructure and in cylindrical vs spherical forms to test for morphology control upon matrix structure development.

### DETAILED DESCRIPTION OF THE DRAWINGS

Carbon-carbon (C—C) composites consists of a carbon additive/filler within a carbon matrix. This carbon matrix is formed after carbonization and graphitization of a carbon precursor material. Fibers made from carbon precursors such as polyacrylonitrile (PAN), rayon or pitch are typically used as the filler weaved in varied directions to get desired properties within a resin or pitch-based matrix formed from a liquid precursor or by impregnation within a matrix formed from a gas precursor.

In the composites, carbon is used as a template or been templated off of the carbon additive. A template is referred to as something that establishes a pattern to guide the formation of a second material around it. This concept is important and largely unexplored in C—C composites. Templating in C—C composites refers to the interfacial interactions between the matrix and the filler to reinforce each other's structure at a molecular level resulting in a ‘molecular template’ of sorts with either one forming a pattern under the influence of the other material.

The development of the matrix nanostructure is directed by that of the embedded carbon additive. The templating spans three length scales:

1. Matrix chemistry controls the extent of nanostructure development (within the matrix).

2. Additive nanostructure controls the direction or type of nanostructure evolution, with the basal versus edge site proportion being the driving factor.

3. Additive morphology determines the spatial direction and lateral extent of nanostructure development at the interface.

Chemistry refers to the type of matrix precursor. Nanostructure refers to the lamellae orientation of the carbon additive. Lamellae may be perpendicular, parallel, or lie at some inclination relative to the interface. Morphology refers to the shape of the additive, i.e. aspect ratio.

The interface acts as a structure-directing agent, i.e., interfacial template, mediated by matrix chemistry.

Matrix chemistry, additive nanostructure and morphology all have roles upon evolution of the nanostructure at the matrix interface and have an impact upon the composite properties.

Matrix chemistry is addressed by using different starting matrix precursors. Graphitizing or non-graphitizing matrix precursors may be used. For example, an aromatic based pitch or a non-aromatic, oxygen-containing polymeric resin may be used. For example, graphitizing carbon materials are derived from asphaltic precursors such as coal-tar and petroleum pitches. These materials are unique in passing through a liquid-crystalline mesophase state prior to carbonization.

In contrast, hard, or non-graphitizing, carbons are usually obtained from thermosetting resins, such as e.g. phenolics and furans, which do not fuse on pyrolysis but, rather, are said to “char in place”. The hard carbons are difficult to graphitize even by heat-treatment at and above 2000° C. The high randomness or the highly cross-linked texture in hard carbons results from the molecular arrangement and orientation that develops during heat-treatment.

Pitch is a complex mixture of aromatic, aliphatic and fused compounds derived either from coal-tar or petroleum. In contrast furan resin, derived by polymerization of resorcinolformaldehyde is a non-graphitizing carbon used in C—C manufacture. Both are commonly used as matrix precursors in LPI. Pitch is a thermoplastic “resin” that passes through a mesophase. Such localized orientation in the liquid-crystalline state would lead one to expect the final, graphitized matrix also to be well oriented in the immediate vicinity of the particle surface—if the surface presents favorably oriented lamellae—i.e. basal plane exposure as hypothesized here. The furan resin is an oxygenated polymer, a well-known thermoset resin producing nongraphitizing carbon. Thermoset resins are usually highly cross-linked, which makes them resistant to thermal graphitization in bulk form, even to temperatures of 3000° C. Such crosslinking is hypothesized to restrict their ability to template from basal planes while favoring their orientation by edge planes—with which the matrix molecules can directly bond. The opposing forms will test the templating hypothesis across a range of length scales. If no templating occurs, the structure of each matrix will remain unaltered relative to the baseline established by the pure matrix precursor without additives. Mechanical and electrical properties will also be unchanged (assuming non-percolation). Alternatively if templating occurs, the matrix interfacial order will be dependent upon that of the embedded nanocarbons. Material properties will change accordingly.

Carbon additive nanostructure is addressed by using an additive with different nanostructures. For example, the carbon additive with surfaces comprised of poorly ordered, short and discontinuous lamellae with a dominant edge site construct or their graphitized form featuring exclusively basal planes may be used.

Additive morphology or shape is addressed by comparatively using additives with different shapes. For example, pseudospherical particles or 1-dimensional cylindrical nanotubes may be used.

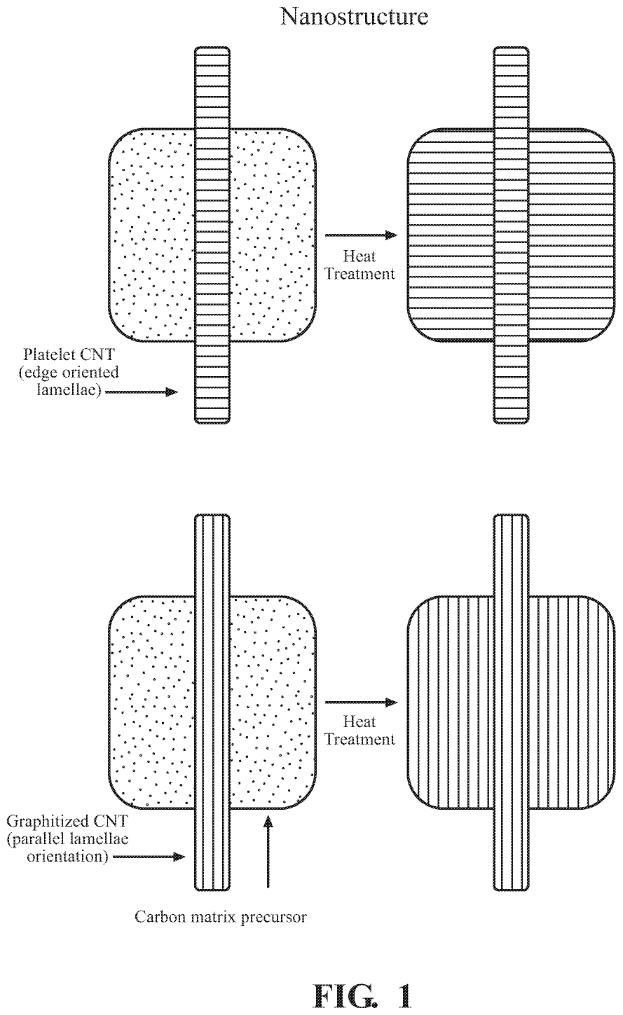

FIG. 1 shows comparatively the effect of additive nanostructure upon the evolution of the nanostructure at the matrix interface. At the top, a platelet carbon nanotube (CNT) with edge-oriented lamellae is used as the additive. At the bottom, graphitized CNT with parallel lamellae orientation is used. The carbon precursor matrix is illustrated in gray while developed interfacial structure formed by heating is indicated by sets of parallel lamellae. Mirroring those of the embedded carbon, matrix lamellae (represented by lines) are drawn oriented parallel or perpendicular to the interface, as directed by the additive's lamellae orientation.

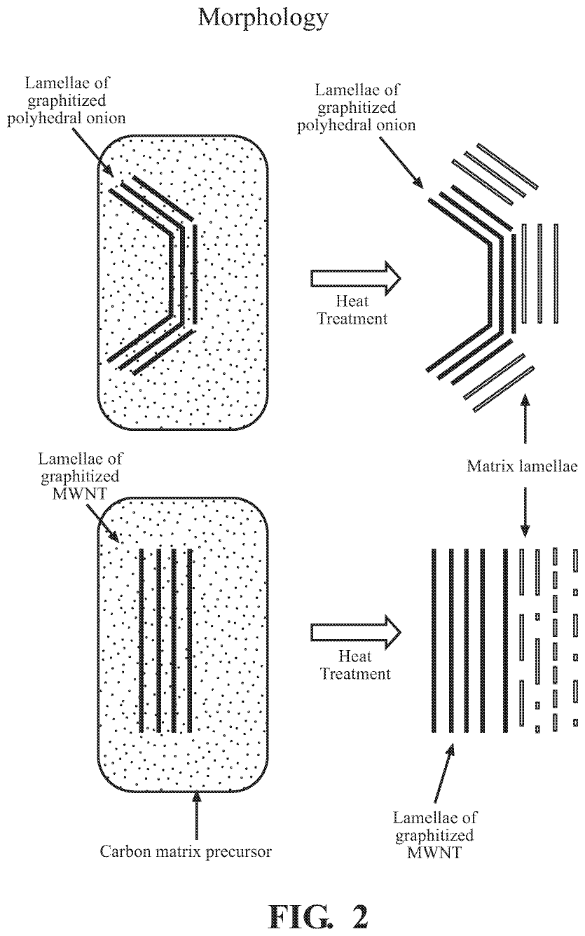

FIG. 2 shows comparatively the effect of additive morphology upon the evolution of the nanostructure at the matrix interface. At the top, the CNT with lamellae of graphitized polyhedral onion is used. At the bottom, graphitized one-dimensional multi-walled CNT (MWNT) is used. Matrix lamellae (represented by lines) are drawn oriented parallel or perpendicular to the interface, as directed by the additive's lamellae orientation.

### Experimental Approach and Embodiments

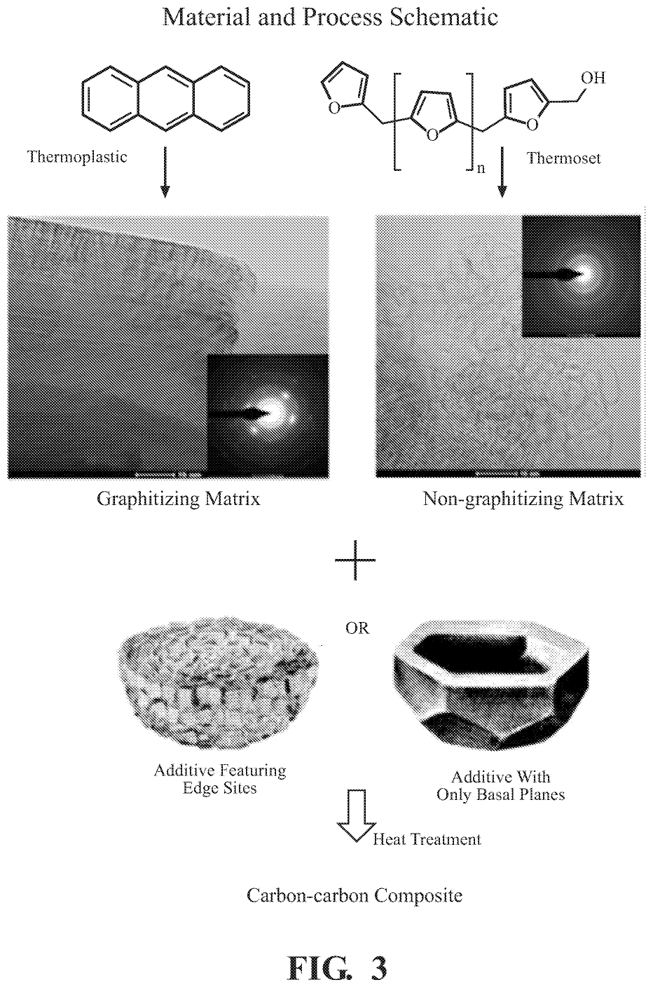

FIG. 3 outlines the experimental approach. Either a graphitizing thermoplastic or non-graphitizing thermoset is used as a matrix precursor. The additives as presented either featuring edge sites or with only basal planes are used. Templating dependence is obtained upon additive nanostructure (edge or basal surface sites) and matrix precursor chemistry. Four matrix and additive (particle) combinations are possible, including: the graphitizing matrix precursor and the graphitized additive; the graphitizing matrix precursor and the non-graphitized additive; the non-graphitizing matrix precursor and the graphitized additive; and the non-graphitizing matrix precursor and the non-graphitized additive. The nanotube analogues for the carbon particles are not shown here. Each thermoset alone produces a very different carbon matrix, as shown by the HRTEM images and selected area diffraction patterns, placed as insets. The highly oriented lamellae arise from the stacking of the aromatic rings of the precursor thermoplastic. The irregular lamellae forming intertwined shells and ribbons arise from the myriad pyrolysis reactions of the thermoset.

For the graphitizing carbon, high temperature heat treatment (HTHT) leads to well-developed lamellae whose periodic stacking is evident from the HRTEM image in FIG. 3. In contrast the nongraphitizing carbon produces myriad nested ribbons during HTHT, wherein each ribbon is comprised of a couple extended stacked lamellae. The perceived closure of voids and hollows accounts for the lack of gas and liquid permeability for such carbons.

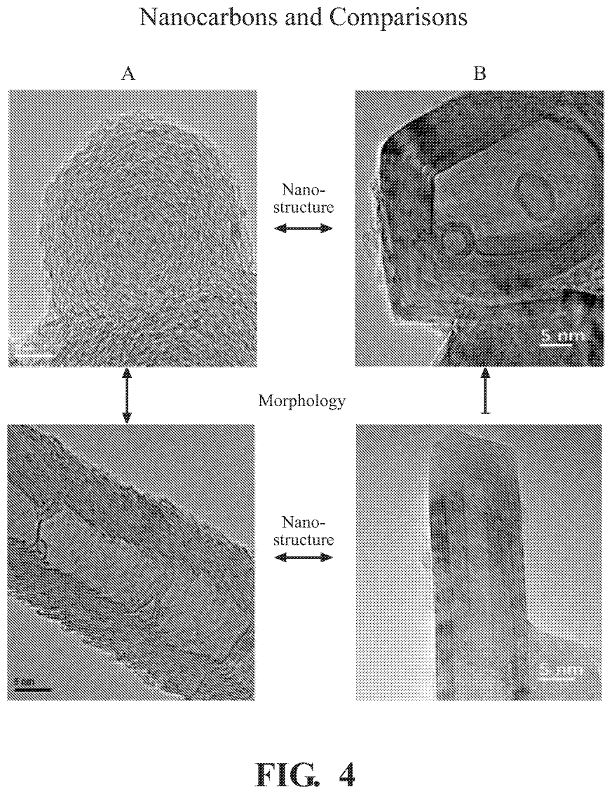

Some model nanocarbon are shown in FIGS. 4a-4d. FIGS. 4a and 4b show a MWNT, presenting lamellae edge plane components and its graphitized forms exposing only basal planes respectively. FIGS. 4c and 4d show a carbon black, presenting lamellae edge plane components and its graphitized forms exposing only basal planes, respectively. All forms present a well-defined, uniform surface, defining a periodic boundary condition.

The non-graphitized (nascent) vs. graphitized forms (horizontal arrows) will test for lamellae orientation control upon matrix nanostructure development. The cylindrical vs. spherical forms (vertical arrows) test for morphology upon matrix structure development. Finally the matrix chemistry, (not illustrated) tests for degree of nanostructure development.

The HRTEM images in FIGS. 4a-4d show their uniformity of morphology and nanostructure. Independent heating studies have shown such model materials to be largely invariant at temperatures below 2000° C. in nascent form, and stable to 3000° C. if pre-graphitized, hence their nanostructure and morphology will remain largely unaltered by limiting heating to 2000° C.

### Fabrication

C—C composites have been synthesized by mixing presynthesized nano-carbons with a matrix. In one example, nanocarbons are multi-walled carbon nanotubes (MWCNTs) 10-30 μm in length or graphene nano-platelets with an X-Y dimension of 1-2 which are embedded in a matrix of novolac, a phenolic resin with a formaldehyde to phenol ratio of less than 1. Here, a 0.8 molar ratio of laboratory grade formaldehyde to phenol was heated on a hot plate under continuous magnetic stirring to which 5 ml hydrochloric acid was added with a pipette to catalyze the polymerization reaction. Once initiated, a sonicated solution of the nano-carbon in methanol was immediately added to the mix and allowed to set, forming novolac impregnated with the nano-carbon. Nano-carbon doping is approximately 5% by weight of the composite. Once cooled and set, the material was subjected to carbonization under an inert atmosphere at 800° C. for 5 hours in a tube furnace. This was followed by high-temperature graphitization heat treatment at 2700° C. for one hour in a Centorr Vacuum Industries graphitization furnace, under an inert.

In another example, the graphene-anthracene composites have been made by mixing pre-synthesized graphene sheets of varying X-Y dimensions within a matrix of anthracene. The filler materials are graphene with X-Y dimensions of (a) 2-5 gm graphene sheets, (b) 1-2 gm as graphene nano-platelets (GNP) and (c) 300-800 nm as reduced graphene oxide (RGO). Each filler material is mixed with laboratory grade anthracene in powdered form to achieve a 2.5% by weight loading of the filler in the matrix. The mixture was then subjected to carbonization under an inert atmosphere at 500° C. for 5 hours in a pre-heated sand-bath in tubing reactors. This was followed by high-temperature graphitization heat treatment at 2700° C. for one hour in a Centorr Vacuum Industries graphitization furnace in an atmosphere of Argon.

In another example, for detailed interfacial analysis by HRTEM to assess interfacial matrix structure, two forms of coupons will be fabricated: 2-D thin and thick films. Thin films will be formed by spin coating using a solvent diluted matrix precursor. Evaporative solvents such as toluene for the pitch or oxygenated organic such as isopropyl alcohol for the furan may be used to reduce the precursor viscosity, thereby facilitating rheological thinning under the centrifugal action. These solvents are readily evaporated, leaving a thin layer. Thick films will be cast using standard molds. As discontinuous composites are being fabricated, vacuum infiltration is not anticipated, but it may yet be applied to remove any trapped gases. Though molds are sized to mechanical test requirements, these samples can also be produced by fabrication of sheets followed by cutting.

The carbon nanomaterials will be added at specific weight percentages to the matrix precursor. With each particle acting as an independent nucleation center for matrix nanostructure, the structure development will then scale with filler amount. Weight percentages ranging from 1-10% are planned, given that 1% may be minimum required to realize material property changes due to net change in matrix interfacial nanostructure while 10% lies near the onset for percolation effects and potential overlapping of adjacent interfacial boundaries. Key to mapping the dependence of properties upon additive amount is the implicit assumption of well-dispersed additive such that it is uniformly distributed throughout the matrix. Extensive mixing aided by the solvents for rheological thinning is a proven method by which to achieve high dispersion.

Both thin and thick film samples will be carbonized under inert atmosphere with temperatures ranging between 500-1000° C., followed by graphitization at ˜2000° C. Such 2-stage processing is characteristic in C—C composite manufacture. Samples at intermediate temperatures will be analyzed to determine the dependence of matrix structure upon temperature during each stage to explicitly map the nanostructure dependence upon temperature. In actual CC composite manufacture the graphitization step can lead to voids, cracks and pores due to gas evolution. For thin films this is not anticipated to be a limitation given the focus upon small sections for microscopic analysis. For the thick films comparison between bulk physical properties prior to and post graphitization will be key indicators of the need to re-impregnate the sample, again followed by sequential stages of carbonization and graphitization.

Varied nanocarbon concentrations and heat treatment temperatures will allow for deconvolution of their relative contributions. Structure and property gains will be mapped as a function of heat treatment temperature to identify domain interface contributions. Varied additive wt. % below, near, and above the percolation threshold will identify the onset of merging overlap between expanded crystalline (templated) domains surrounding each nanocarbon. The reference system will be the film-only case. Comparison of the non-graphitized and graphitized additives at varied mass loadings and process temperature will aid differentiation of the interface contribution for these complimentary additives by the relative rates of increase in a) nanostructure amount, b) electrical conductivity and c) modulus and strength.

### Characterization

### Electrical and Mechanical Property Tests

Electrical conductivity measurements will be performed in the four-point configuration by measuring the voltages at different currents. Interfacial structure in the form of extended, stacked lamellae will promote conductivity analogous to few-layer graphene segments. Gains will be related to additive loading and graphitization temperature with reference to interfacial nanostructure observed via HRTEM.

The mechanical properties and fracture behavior will be studied using the three-point bending test according to ASTM D790, recording the load and deflection values as a function of time. From the stress-strain curves comparative maximum stresses, ultimate strains, flexural strength modulus will be extracted and compared. The fracture surfaces after flexural test will be observed using scanning electron microscopy (SEM). (Polishing tends to damage the nearsurface structures and leaves behind a thin layer of polishing debris.)

In continuous C—C composites, when fiber-matrix bonding is very strong brittle fracture is frequently observed. The explanation is that strong bonding permits the development of high crack tip stresses at the fiber-matrix interface; cracks that initiate in either fiber or matrix can then propagate through the composite. However if the matrix or the fiber-matrix interface is very weak or micro-cracked then the primary advancing crack can be deflected at such weakened interfaces or cracks. This is the Cook-Gordon theory for strengthening brittle solids.

As an alternative, localized orientation in the immediate vicinity of the particle (or carbonfiber) interface would decouple strong fiber-matrix bonding from high stress transfer. High stress transfer requires strong interfacial bonding in reinforced composites, with tradeoffs between modulus and strength. With interfacial lamellae parallel to but offset from the fiber surface into the matrix—in effect extending the fiber size or “domain”, high stress transfer can yet occur without strong bonding to the fiber surface. (Assume for this discussion that the fiber lamellae run parallel to its axis). Lamellae oriented parallel to the fiber surface will well transfer stress to the fiber as each possess the modulus of a graphene segment. Moreover such graphene layers are structurally equivalent to those in the fiber and have equivalent fracture strength. However as these layers are only weakly bonded by π″-π″ interaction they can slide against each other and the fiber in response to compression or tension forces. Oppositely matrix lamellae oriented perpendicular to the fiber would likely weaken the composite against fracture by concentrating stresses and directly propagating micro-cracks to the fiber surface. A lower fracture strength would be expected. Yet if the fiber lamellae were similarly oriented parallel to those in the matrix, the preceding description and outcome would not apply.

Modulus enhancement in pitch-based C/C has been widely reported, but whether the effect is due to the matrix or to an increase in the fiber modulus, resulting from high-temperature heat treatment-induced structural changes in the fiber, has not been clarified. Therein lies the basis for a) HRTEM to directly examine the interface, b) use of model carbon particle with well-defined and uniform surfaces, b) nanoscale additives (carbon blacks, nanotubes) permitting access to interfacial imaging, c) nascent and graphitized forms for well-defined uniform surfaces and d) final heat treatment (graphitization) temperature below that where additives will substantially change, as noted previously.

### Microscopy and Image Analyses

HRTEM will be the prime diagnostic of the carbon film evolution from amorphous to varied types and degrees of nanostructure. With the matrix and embedded nanocarbon sufficiently thin to electron beam transmission (<100 nm), the near-interfacial matrix structure can be viewed directly by HRTEM and quantified by our fringe analysis algorithms. FIG. 4 outlines the capability of these algorithms. Their application permits translating image data to quantitative distributions of physical scale (e.g., lamellae lengths) for statistical analyses. During such processing, binary, so-called “skeletal” images are created, as illustrated in FIG. 4. Lines representing the lamellae can readily be compared both as a spatial map and statistically as a distribution for comparisons. Reference tests of matrix-only studies will differentiate changes due to the embedded nanocarbons imposing a templating action. Characterization and quantification of nanostructure will be made as a function of lateral distance from the nanocarbon-film interface. These structure analyses will statistically differentiate of matrix resins and the varied additive's templating role upon lamellae order and spatial extent.

### Spectroscopic Characterization

Electron Energy Loss Spectroscopy (EELS) is a powerful method to unveil spatially resolved chemistry—having been widely applied to amorphous and nanocrystalline carbon films. EELS will be applied to resolve spatial variations in structure as reflected by bonding—from the particle-matrix interface—extending outward. In STEM mode, the EELS spatial resolution is ˜1 nm. Applying the standard background correction, the C1s signature peak may be resolved into σ* and π* orbitals, associated with sp3 and sp2 hybridized carbon, respectively. This atomic scale (chemistry) information will complement the physical structure data as provided by HRTEM.

As will be clear to those of skill in the art, the embodiments of the present invention illustrated and discussed herein may be altered in various ways without departing from the scope or teaching of the present invention. Also, elements and aspects of one embodiment may be combined with elements and aspects of another embodiment. It is the following claims, including all equivalents, which define the scope of the invention

1. A method of fabricating a carbon-carbon composite, comprising the steps of:
providing a carbon-based matrix precursor being nominal limits including a graphitizing and non-graphitizing material or a continuum of graphitizing/non-graphitizing material between the nominal limits;
providing a carbon nanomaterial additive presenting basal or edge site carbon atoms or a combination of both;
mixing the matrix precursor with the carbon nanomaterial additive forming a polymeric matrix impregnated with the carbon nanomaterial additive;
heating the impregnated polymeric matrix under an inert atmosphere, with temperatures ranging between 350-1100° C. for carbonization followed by graphitization at a temperature greater than 1800° C.;
thereby forming the carbon-carbon composite composed of the matrix and additive, by templating or bond formation between the matrix and additive, wherein the nano- or micro-structure of the matrix is controlled by the additive, wherein the matrix interacts physically or chemically with the carbon additive's surface, at least 1-D nano-scale or micro-scale structural changes beginning at the interface between the matrix and additive and propagating outward from the interface into the matrix, thus adjusting or altering the nano- or micro-structures in the matrix that would not naturally occur in the absence of the additive.

2. The method according to claim 1, wherein the mixing of the matrix precursor with the additive is by mechanical action, solvent mediation, solvent assist, by hand, machine or other automation or instrumentation involving physical contact between the matrix precursor and additive.

3. The method according to claim 1, wherein the heating is done under sub- or over-atmospheric pressure, including vacuum, using any container, vessel or other means for holding the matrix precursor mixture for exposure to convective, radiative, thermal, or photonic energy sources.

4. The method according to claim 1, wherein the additive is selected from a group including graphitic materials, non-graphitic materials, and mixtures or hybrids of graphitic and non-graphitic materials.

5. The method according to claim 1, wherein the additive comprises synthetic carbon material or naturally found or produced carbon material.

6. The method according to claim 1, wherein the additive comprises nantotubes, graphene, carbon black or carbon particles.

7. The method according to claim 4, wherein the carbon-carbon composite has a nanostructure selected from one of four nominal limits of structures resulting from one of four possible combinations of the matrix precursor and additive including the graphitizing matrix precursor and the graphitic additive, the graphitizing matrix precursor and the non-graphitic additive, the non-graphitizing matrix precursor and the graphitic additive, and the non-graphitizing matrix precursor and the non-graphitic additive.

8. The method according to claim 1, wherein the matrix precursor is in the form of liquid, powder, semi-solid, liquid crystal mesophase or a material having fluidity or flexibility.

9. The method according to claim 1, wherein the additive is in the form of liquid or powder.

10. The method according to claim 1, wherein the graphitizing matrix precursor is a petroleum pitch, coal-tar, waste polymeric or recycled polymeric plastics or converted resins, or other heavy distillate fractions, or carbon forms produced from recycled or re-processed materials.

11. The method according to claim 1, wherein the matrix precursor is the non-graphitizing matrix precursor including a phenolic or furan based resin or polymeric systems.

12. The method according to claim 4, wherein the non-graphitic additive is graphene nano-platelets with a dimension of 1-2 μm.

13. The method according to claim 1, further comprising reducing viscosity of the matrix precursor by using evaporative solvents.

14. The method according to claim 1, wherein the carbon nanomaterial additive is added at specific weight percentage to the matrix precursor.

15. The method according to claim 1, wherein the additive comprises pseudo-spherical particles or 1-dimensional nanotubes.

16. The method according to claim 1, wherein at least 1-D nano-scale or micro-scale structural changes beginning at the interface between the matrix and additive during carbonization and propagating outward from the interface into the matrix during subsequent graphitization.
